(19) United States
(12) Patent Application Publication
(10) Pub. No.: US 2014/0152462 A1
(43) Pub. Date: Jun. 5, 2014

(54) REMOTE-SIGNAL DATA ACQUISITION METHOD AND DEVICE

(71) Applicant: Jun Yang, Shenzhen (CN)

(72) Inventor: Jun Yang, Shenzhen (CN)

(73) Assignee: AEROSPACE SCIENCE & INDUSTRY SHENZHEN (GROUP) CO., LTD., Shenzhen (CN)

(21) Appl. No.: 14/129,818

(22) PCT Filed: Aug. 7, 2012
(86) PCT No.: PCT/CN2012/079790

§ 371 Date: Dec. 27, 2013

(30) Foreign Application Priority Data
Nov. 14, 2011 (CN) 201110359700.6

(51) Int. Cl. G08C 19/16

(52) U.S. Cl. CPC G08C 19/16
USPC 340/870.01

(57) ABSTRACT

The present invention relates to a data acquiring field and provides a remote-signal data acquiring method and device. In the present invention, the remote-signal data are received according to the user's command or a fixed frequency, the currently received remote-signal data are compared with previously received remote-signal data. If the currently received remote-signal data are different from the previously received remote-signal data, a position-alternation indication signal is generated, and the currently received remote-signal data are acquired according to the position-alternation indication signal, thereby the remote-signal data are acquired only when the remote-signal data generate position-alternation and remains unchanged when the remote-signal data do not generate position-alternation. Therefore, the problems of long processing time and low acquiring effect to the remote-signal data of the known method for acquiring the remote-signal data are solved.

### TECHNICAL FIELD

The present invention relates to data acquiring field, and more particularly, to a remote-signal acquiring method and device.

### BACKGROUND

In order to ensure properly running of a power system, it is required to monitor the state of the opening and closing operation of the switch of the line of the power system in real time. The remote-signals are acquired and updated in the monitor center to make the monitoring person know the states of the switch of the line in time.

In the known technology, the remote-signal data are acquired by a real time updating way. Whether the remote-signal data generate position-alternation, the system acquires and updates the remote-signal data continuously. The above described way can ensure to acquire and update the remote-signal data in real time, but the process time will be increased and the acquiring effect of the remote signals will be reduced while the system acquires and updates the remote-signal data without differing whether the remote-signal data generate position-alternation.

Therefore, the known method for acquiring the remote-signal has the disadvantages of long processing time and low acquiring effect to the remote signals.

### SUMMARY

The object of the present invention is to provide a remote-signal acquiring method for solving the problems of long processing time and low acquiring effect of the prior art.

The present invention is realized by the remote-signal acquiring method, the method includes:
a: receiving remote-signal data from multiple channels and storing the received remote-signal data to a temporary storage space of a first predetermined storage space;
b: comparing the currently received remote-signal data of multiple channels with previously received remote signals stored in a permanent storage unit of the first predetermined storage space to determine whether the currently received remote-signal data generate position-alternation, if yes, implementing step c, if no, returning to step a;
c: generating a position-alternation indicating signal; and
d: acquiring the currently received remote signals from the first predetermined storage space and storing the acquired currently received remote signals to a second predetermined storage space, and then returning to step a.

Another object of the present invention is for providing a remote-signal data acquiring device. The device includes a remote-signal data obtaining unit, a position-alternation determining module, a position-alternation indication signal generating unit, a triggering unit, a remote-signal data acquiring unit, a first storage unit, and a second storage unit, wherein the first storage unit includes a temporary storage unit and a permanent storage unit, wherein:

the remote-signal data obtaining unit is for receiving remote-signal data from multiple channels and storing the received remote-signal data to a temporary storage space of a first predetermined storage space;

the position-alternation determining module is for comparing the currently received remote-signal data of multiple channels with previously received remote signals stored in a permanent storage unit of the first predetermined storage space to determine whether the currently received remote-signal data generate position-alternation;

if yes, implementing step c, if no, returning to step a;

the position-alternation indication signal generating unit is for generating a position-alternation indicating signal if the currently received remote-signal data generate position-alternation;

the triggering unit is for triggering a remote-signal comparing unit if the currently received remote-signal data do not generate position-alternation;

the temporary storage unit is for storing the currently received remote-signal data of multiple-channels;

the permanent storage unit if for storing the previously received remote-signal data of multiple channels and storing the currently received remote-signal data of multiple channels when there are not the remote-signal data stored therein;

the remote-signal data acquiring unit is for acquiring the currently received remote signals from the first storage unit and storing the acquired currently received remote signals to a second storage unit; and

the second storage unit is for storing the currently received remote signals acquired by the remote-signal acquiring unit.

In the present invention, the remote-signal data of multiple channels are received according to the user's command or a fixed frequency, the currently received remote-signal data are compared with previously received remote-signal data. If the currently received remote-signal data are different from the previously received remote-signal data, a position-alternation indication signal is generated, and the currently received remote-signal data are acquired according to the position-alternation indication signal, thereby the remote-signal data are acquired only when the remote-signal data generate position-alternation and remains unchanged when the remote-signal data do not generate position-alternation. Therefore, the problems of long processing time and low acquiring effect to the remote-signal data of the known method for acquiring the remote-signal data are solved.

### BRIEF DESCRIPTION OF THE DRAWINGS

FIG. 1 is a flowchart of a remote-signal data acquiring method in accordance with an embodiment of the present invention.

FIG. 2 is a flowchart of a step of the remote-signal data acquiring method of FIG. 1.

FIG. 3 a structure diagram of a remote-signal data acquiring device in accordance with an embodiment of the present invention.

### DETAILED DESCRIPTION OF THE PREFERRED EMBODIMENTS

In order to make the objects, technology schemes, and advantages of the present invention are more clearly, embodiments of the present invention will be explained below in detail with reference to the accompanying drawings. It should be understood that the embodiments described below are only used to explain the present invention, and not intend to limit the present invention.

In the embodiment of the present invention, the remote-signal data are received according to the user's command or a fixed frequency, the currently received remote-signal data are compared with previously received remote-signal data. If the currently received remote-signal data are different from the previously received remote-signal data, a position-alternation indication signal is generated, and the currently received remote-signal data are acquired according to the position-alternation indication signal, thereby, the remote-signal data are acquired only when the remote-signal data generate position-alternation and remains unchanged when the remote-signal data do not generate position-alternation. Therefore, the time for processing the remote-signal data is shortened, and the effect for acquiring the remote-signal data is improved.

The detail description about the present invention refers to the following embodiments.

### Embodiments

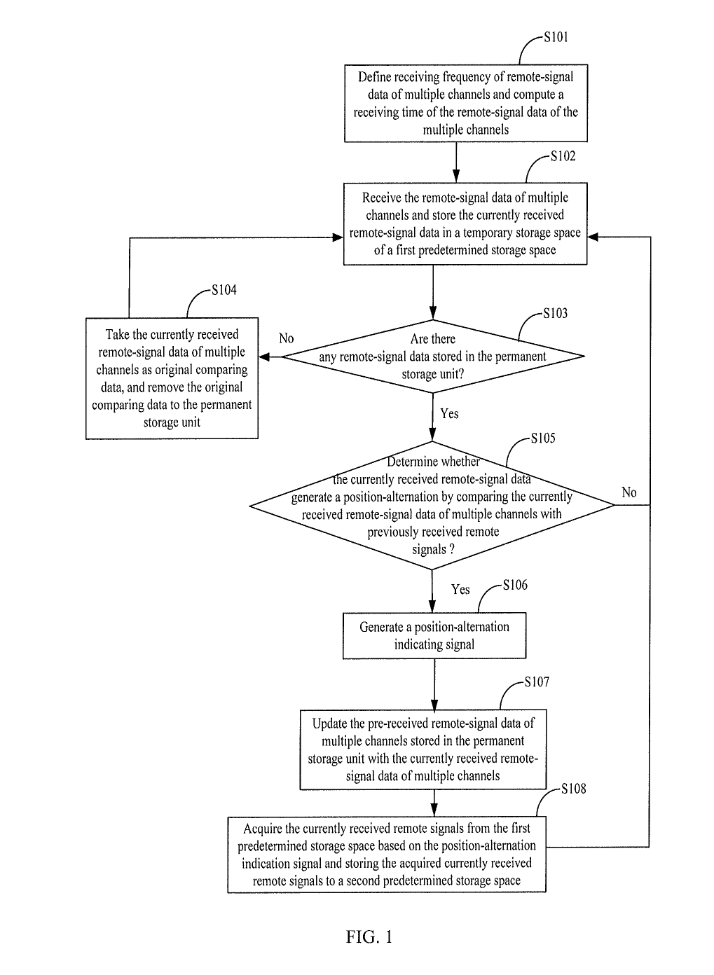

FIG. 1 shows a flow chart of a remote-signal data acquiring method in accordance with an embodiment of the present invention, for easy description, only related pars of the embodiment of the present invention are shown.

In step S101, defining receiving frequency of the remote-signal data of the multiple channels and computing a receipt time of the remote-signal data of the multiple channels.

In step S102, receiving remote-signal data of multiple channels and storing the currently received remote-signal data to a temporary storage space of a first predetermined storage space.

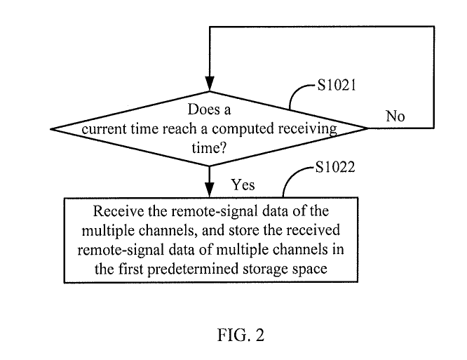

Referring to FIG. 2, the step 102 further includes:

Step 1021: determining whether the current time reaches to the computed receipt time, if yes, a step S1022 is implemented, if no, the step S102 is implemented;

Step 1022: receiving the remote-signal data of the multiple channels, and storing the received remote-signal data of multiple channels to the temporary storage space of the first predetermined storage space.

In step S103, determining whether there are the remote-signal data stored in the permanent storage unit of the first predetermined storage space, if yes, a step 105 is implemented, if no, a step 104 is implemented.

In step S104, taking the currently received remote-signal data of multiple channels as original comparing data, and removing the original comparing data to the permanent storage unit, and then returning to the step S101.

In the embodiment of the present invention, the step S103 and S104 can ensure that the currently received remote-signal data can be removed from the temporary storage unit to the permanent storage unit when the remote-signal data are acquired firstly (namely, there are not remote-signal data stored in the permanent storage unit), thus can ensure the position-alternation determination can be done to the remote-signal data received later based on the original comparing data.

In step S105, comparing the currently received remote-signal data of multiple channels with previously received remote signals to determine whether the currently received remote-signal data generate position-alternation, if yes, implementing a step S106, if no, returning to the step S102;

The step S105 includes steps of:

Respectively comparing the currently received remote-signal data of each of the multiple channels with the previously received remote-signal of each of the multiple channels orderly;

Determining the currently received remote-signal data of multiple channels are position-alternation if the currently received remote-signal data of one of the multiple channels is different from the previously received remote-signal data of a corresponding one of the multiple channels, otherwise, determining the currently received remote-signal data of multiple channels are not position-alternation.

In step S106, generating a position-alternation indicating signal.

In step S107, updating the previously received remote-signal data of multiple channels stored in the permanent storage unit with the currently received remote-signal data of multiple channels.

In the embodiment of the present invention, the step 107 updates the previously received remote-signal data of multiple channels with the currently received remote-signal data of multiple channels to ensure the permanent storage unit stores the newest remote-signal data, thus enables the system to call the newest remote-signal data to analyses later.

In step S108, based on the position-alternation indicating signal, acquiring the currently received remote signals from the first predetermined storage space and storing the acquired currently received remote signals to a second predetermined storage space, and then returning to the step S102.

In the embodiment of the present invention, the remote-signal data are received according to the user's command or a fixed frequency, the currently received remote-signal data are compared with previously received remote-signal data. If the currently received remote-signal data are different from the previously received remote-signal data, a position-alternation indication signal is generated, and the currently received remote-signal data are acquired according to the position-alternation indication signal, thereby the remote-signal data are acquired only when the remote-signal data generate position-alternation and remains unchanged when the remote-signal data do not generate position-alternation. Therefore, the problems of long processing time and low acquiring effect to the remote-signal data of the known method for acquiring the remote-signal data are solved.

In the embodiment of the present invention, the frequency for receiving the remote-signal data of multiple channels are predefined, after receiving the remote-signal data in a first time, the receipt time of the following received remote-signal data can be computed. Before receiving the remote-signal data, first determining whether the current time reaches to the computed receipt time, if yes, receiving the remote-signal data, if no, waiting until the time reaches to the computed receipt time.

In person skilled in this art can understand all the steps or the parts of the steps of the above described embodiment can be implemented by the hardware controlled by a program. The program can be stored in a computer readable storage medium, such as ROM/RAM, magnetic disk, or compact disc.

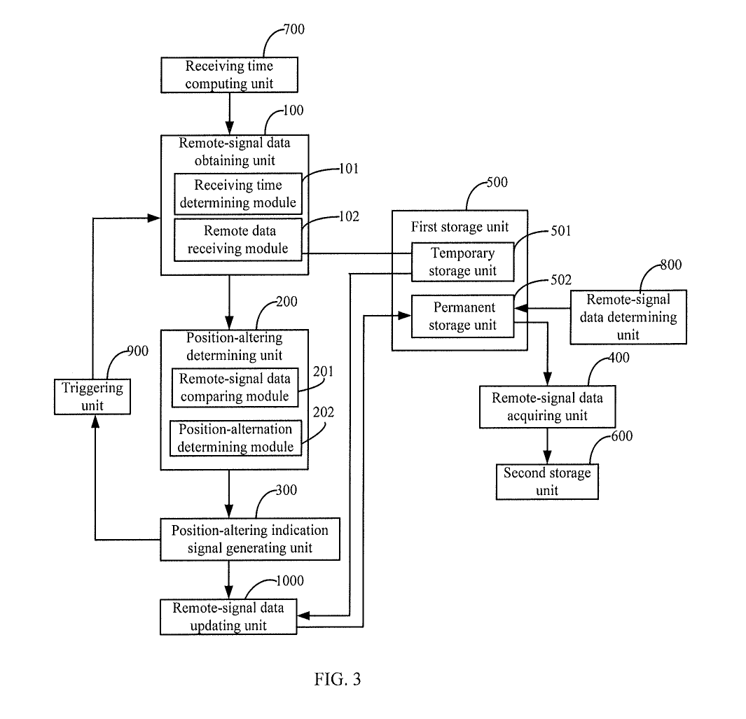

FIG. 3 shows a structure diagram of a remote-signal data acquiring device in accordance with the embodiment of the present invention, for easy description, only related pars of the embodiment of the present invention are shown.

The remote-signal data acquiring device includes a remote-signal data acquiring unit 100, a position-alternation determining module 200, a position-alternation indication signal generating unit 300, a remote-signal data acquiring unit 400, a first storage unit 500, and a second storage unit 600, wherein the first storage unit 500 includes a temporary storage unit 501 and a permanent storage unit 502.

The remote-signal data acquiring unit 100 is for receiving remote-signal data of multiple channels and storing the received remote-signal data to the temporary storage space 501.

The remote-signal data acquiring unit 100 includes:

A receipt time determining module 101 for determining whether the current time reaches to the computed receipt time.

A remote data receiving module 102 for receiving the remote-signal data of multiple-channels and storing the currently received remote-signal data of multiple-channels in the temporary storage unit 501.

The position-alternation determining module 200 is configured for comparing the currently received remote-signal data of multiple channels with previously received remote signals stored in a permanent storage unit of the first predetermined storage space to determine whether the currently received remote-signal data generate position-alternation.

The position-alternation determining module 200 includes:

A remote-signal data comparing module 201 for respectively comparing the currently received remote-signal data of each of the multiple channels with the previously received remote-signal of each of the multiple channels orderly;

A position-alternation determining module 202 for determining the currently received remote-signal data of multiple channels are position-alternation if the currently received remote-signal data of one of the multiple channels is different from the previously received remote-signal data of a corresponding one of the multiple channels, otherwise, determining the currently received remote-signal data of multiple channels are not position-alternation.

The position-alternation indication signal generating unit 300 is configured for generating a position-alternation indicating signal if the currently received remote-signal data generate position-alternation.

The temporary storage unit 501 is configured for storing the currently received remote-signal data of multiple-channels.

The permanent storage unit 502 is configured for storing the previously received remote-signal data of multiple channels and storing the currently received remote-signal data of multiple channels when there are not the remote-signal data stored therein.

The remote-signal data acquiring unit 400 is configured for acquiring the currently received remote signals from the first storage unit 500 and storing the acquired currently received remote signals to a second storage unit 600.

The second storage unit 600 is configured for storing the currently received remote signals acquired by the remote signal acquiring unit 400.

The remote-signal data acquiring device further includes:

A receipt time computing unit 700 for defining receiving frequency of the remote-signal data of the multiple channels and computing a receipt time of the remote-signal data of the multiple channels;

A remote-signal data determining unit 800 for determining whether there are the remote-signal data stored in the permanent storage unit 502;

A triggering unit 900 for triggering the remote-signal comparing unit 201 if the currently received remote-signal data do not generate a position-alternation;

A remote-signal data updating unit 1000 for updating the previously received remote-signal data of multiple channels stored in the first storage unit with the currently received remote-signal data of multiple channels and removing the currently received remote-signal data from the temporary storage unit 501 to the permanent storage unit 502.

In the embodiment of the present invention, the remote-signal data are received according to the user's command or a fixed frequency, the currently received remote-signal data are compared with previously received remote-signal data. If the currently received remote-signal data are different from the previously received remote-signal data, a position-alternation indication signal is generated, and the currently received remote-signal data are acquired according to the position-alternation indication signal, thereby the remote-signal data are acquired only when the remote-signal data generate position-alternation and remains unchanged when the remote-signal data do not generate the position-alternation. Therefore, the problems of long processing time and low acquiring effect to the remote-signal data of the known method for acquiring the remote-signal data are solved.

The above description is just the preferred embodiments of the present invention, and is not intend to limit the present invention. The scope of the invention is indicated by the appended claims rather than by the foregoing description; and all changes which come within the meaning and range of equivalency of the claims are intended to be embraced therein.

What is claimed is:

1. A remote-signal data acquiring method, comprising:
a: receiving remote-signal data from multiple channels and storing the received remote-signal data in a temporary storage space of a first predetermined storage space;
b: comparing the currently received remote-signal data of multiple channels with previously received remote signals stored in a permanent storage unit of the first predetermined storage space to determine whether the currently received remote-signal data generate a position-alternation, if yes, implementing step c, if no, returning to step a;
c: generating a position-alternation indicating signal; and
d: based on the position-alternation indicating signal, acquiring the currently received remote signals from the first predetermined storage space and storing the acquired currently received remote signals in a second predetermined storage space, and then returning to step a.

2. The remote-signal data acquiring method as claimed in claim 1, before step a, further comprising a step of:
defining receiving frequency of the remote-signal data of the multiple channels and computing a receipt time of the remote-signal data of the multiple channels;
wherein the step a further comprising:
a1: determining whether the current time reaches to the computed receipt time, if yes, a step a2 is implemented, if no, the step a1 is implemented;
a2: receiving the remote-signal data of the multiple channels, and storing the received remote-signal data of multiple channels in the first predetermined storage space.

3. The remote-signal data acquiring method as claimed in claim 1, between the step a and step b, further comprising following steps of:
determining whether there are the remote-signal data stored in the permanent storage unit, if yes, step b is implemented, if no, taking the currently received remote-signal data of multiple channels as original comparing data, and removing the original comparing data to the permanent storage unit, and then returning to the step a.

4. The remote-signal data acquiring method as claimed in claim 1, between the step c and the step d, further comprising a steps of:
updating the previously received remote-signal data of multiple channels stored in the permanent storage unit with the currently received remote-signal data of multiple channels.

5. The remote-signal data acquiring method as claimed in claim 1, wherein the step b further comprises:
respectively comparing the currently received remote-signal data of each of the multiple channels with the previously received remote-signal of each of the multiple channels orderly;
determining the currently received remote-signal data of multiple channels are position-alternation if the currently received remote-signal data of one of the multiple channels is different from the previously received remote-signal data of a corresponding one of the multiple channels, otherwise, determining the currently received remote-signal data of multiple channels are not position-alternation.

6. A remote-signal data acquiring device, comprising a remote-signal data acquiring unit, a position-alternation determining module, a position-alternation indication signal generating unit, a triggering unit, a remote-signal data acquiring unit, a first storage unit, and a second storage unit, wherein the first storage unit includes a temporary storage unit and a permanent storage unit, wherein:
the remote-signal data acquiring unit is configured for receiving remote-signal data from multiple channels and storing the received remote-signal data to a temporary storage space of a first predetermined storage space;
the position-alternation determining module is configured for comparing the currently received remote-signal data of multiple channels with previously received remote signals stored in a permanent storage unit of the first predetermined storage space to determine whether the currently received remote-signal data generate position-alternation;
if yes, implementing step c, if no, returning to step a;
the position-alternation indication signal generating unit is configured for generating a position-alternation indicating signal if the currently received remote-signal data generate position-alternation;
the triggering unit is configured for triggering a remote-signal comparing unit if the currently received remote-signal data do not generate position-alternation;
the temporary storage unit is configured for storing the currently received remote-signal data of multiple-channels;
the permanent storage unit is configured for storing the previously received remote-signal data of multiple channels and storing the currently received remote-signal data of multiple channels when there are not the remote-signal data stored therein;
the remote-signal data acquiring unit is configured for acquiring the currently received remote signals from the first storage unit and storing the acquired currently received remote signals to a second storage unit; and
the second storage unit is configured for storing the currently received remote signals acquired by the remote-signal acquiring unit.

7. The remote-signal data acquiring device as claimed in claim 6, further comprising:
a receipt time computing unit for defining receiving frequency of the remote-signal data of the multiple channels and computing a receipt time of the remote-signal data of the multiple channels;
and the remote-signal data obtaining unit comprising:
a receipt time determining module for determining whether the current time reaches to the computed receipt time;
a remote signals receiving and storing unit for receiving the remote-signal data of the multiple channels, and storing the received remote-signal data of multiple channels in a temporary storage unit if the current time reaches the computed receipt time.

8. The remote-signal data acquiring device as claimed in claim 6, further comprising:
a remote-signal data determining unit for determining whether there are the remote-signal data stored in the permanent storage unit;
a remote-signal data updating unit for updating the previously received remote-signal data of multiple channels stored in the permanent storage unit with the currently received remote-signal data of multiple channels and removing the currently received remote-signal data from the temporary storage unit to the permanent storage unit.

9. The remote-signal data acquiring device as claimed in claim 6, wherein the position-alternation determining module comprising:
a remote-signal data comparing module for respectively comparing the currently received remote-signal data of each of the multiple channels with the previously received remote-signal of each of the multiple channels orderly;
a position-alternation determining module for determining the currently received remote-signal data of multiple channels are position-alternation if the currently received remote-signal data of one of the multiple channels is different from the previously received remote-signal data of a corresponding one of the multiple channels, otherwise, determining the currently received remote-signal data of multiple channels are not position-alternation.
